(19) United States
(12) Patent Application Publication
(10) Pub. No.: US 2026/0326162 A1
(43) Pub. Date: Oct. 22, 2026

(54) CLEANING DEVICE AND MULTI-FUNCTIONAL CLEANING SYSTEM

(71) Applicant: PENGCHENG CUI, Shenzhen (CN)

(72) Inventor: PENGCHENG CUI, Shenzhen (CN)

(21) Appl. No.: 19/578,599

(22) Filed: Mar. 25, 2026

(51) Int. Cl. B08B 3/10; B08B 3/12

(52) U.S. Cl. CPC B08B 3/102; B08B 3/12

(57) ABSTRACT

A cleaning device and a multi-functional cleaning system are disclosed. The cleaning device includes at least one driving assembly and at least one cleaning assembly, each driving assembly being configured to drive a respective cleaning assembly. The driving assembly includes a driving motor disposed outside a cleaning chamber of the cleaning system and a driving rotor coaxially fixed to an output shaft of the driving motor. The cleaning assembly includes a driven rotor. Both the driving rotor and the driven rotor are magnetic. The driven rotor is disposed inside the cleaning chamber and operatively positioned relative to the driving rotor. Rotation of the driven rotor causes turbulent water flow within the cleaning chamber. When the driving rotor rotates, it drives the driven rotor to rotate through magnetic coupling. This arrangement ensures the sealing of the cleaning chamber of the cleaning device and prevents water from penetrating to the motor.

### TECHNICAL FIELD

The present disclosure pertains to the field of household electrical appliances, and more particularly, to a cleaning device and a multi-functional cleaning system.

### BACKGROUND

Household cleaning devices represent an ideal option for those seeking an efficient and convenient lifestyle. These devices enable fully automated operation, where a single button press efficiently removes pesticide residues and bacteria in minutes, without requiring manual scrubbing, soaking, or monitoring. In contrast to labor-intensive traditional methods, they free users' hands entirely, rendering ingredient preparation exceptionally simple and rapid, thereby significantly conserving time and effort while converting kitchen tasks into a labor-saving, worry-free process. Conventional cleaning devices typically use a motor to directly connect to an impeller to drive its rotation, which in turn causes water flow to move items needing cleaning, such as makeup brushes, thereby completing the cleaning process. However, this direct drive method requires perforating the bottom of the cleaning chamber of the device to connect the motor's output shaft with the impeller. This driving method is prone to create sealing problems in the cleaning chamber, which in turn allows water to seep from the cleaning chamber to the motor, resulting in a shortened operational lifespan of the motor.

### SUMMARY

To ensure the sealing of the cleaning chamber of the cleaning device and to prevent water from penetrating to the motor, the present disclosure provides a cleaning device and a multi-functional cleaning system.

In a first aspect, the present disclosure provides a cleaning device for a multi-functional cleaning system. The cleaning device includes at least one driving assembly and at least one cleaning assembly, with each driving assembly configured to drive a respective cleaning assembly. The driving assembly includes a driving motor disposed outside a cleaning chamber of the cleaning system and a driving rotor coaxially fixed to an output shaft of the driving motor. The cleaning assembly includes a driven rotor disposed inside the cleaning chamber and operatively positioned relative to the driving rotor. Both the driving rotor and the driven rotor are magnetic, and the rotation of the driving rotor drives the driven rotor to rotate via magnetic coupling to generate turbulent water flow within the cleaning chamber.

Optionally, the cleaning device further includes a cleaning cover. The cleaning cover has mesh holes for water to pass through. The cleaning cover is disposed within the cleaning chamber and covers each cleaning assembly at the bottom of the cleaning chamber.

Optionally, the cleaning cover is detachably connected to a cleaning box.

Optionally, the cleaning cover is maintained at the bottom of the cleaning chamber by its own weight and covers the cleaning assemblies.

Optionally, the driven rotor is configured to rotate at the bottom of the cleaning chamber, or the driven rotor is configured to rotate on a cover surface of the cleaning cover that faces the bottom of the cleaning chamber.

Optionally, the cleaning assembly further includes a positioning shaft. The positioning shaft is fixed to the bottom of the cleaning chamber, and the driven rotor is rotatably mounted on the positioning shaft; or the positioning shaft is fixed to the cover surface of the cleaning cover that faces the bottom of the cleaning chamber, and the driven rotor is rotatably mounted on the positioning shaft.

Optionally, the driven rotor is provided with a plurality of turbulence-inducing grooves penetrating therethrough, wherein the turbulence-inducing grooves are uniformly distributed circumferentially around an axis of the driven rotor.

Optionally, the cleaning device further includes an ultrasonic cleaning module for ultrasonically cleaning items placed within the cleaning chamber.

Optionally, the cleaning device further includes a heating module configured to heat the water flow within the cleaning chamber.

In a second aspect, the present disclosure further provides a multi-functional cleaning system, comprising a cleaning box, a cleaning device, and a control mechanism. The cleaning box is provided with a cleaning chamber for cleaning. The cleaning device includes at least one driving assembly and at least one cleaning assembly, with each driving assembly configured to drive a respective cleaning assembly. The driving assembly includes a driving motor disposed in the cleaning box and disposed outside the cleaning chamber, and a driving rotor coaxially fixed to an output shaft of the driving motor. The cleaning assembly includes a driven rotor disposed inside the cleaning chamber and operatively positioned relative to the driving rotor. Both the driving rotor and the driven rotor are magnetic, and the rotation of the driving rotor drives the driven rotor to rotate via magnetic coupling to generate turbulent water flow within the cleaning chamber. The control mechanism is disposed in the cleaning box and is configured to control the cleaning device.

Optionally, the cleaning device further includes a cleaning cover. The cleaning cover has mesh holes for water to pass through. The cleaning cover is disposed inside the cleaning chamber and covers each cleaning assembly at the bottom of the cleaning chamber.

Optionally, the cleaning cover is detachably connected to the cleaning box.

Optionally, the cleaning cover is maintained at the bottom of the cleaning chamber by its own weight and covers the cleaning assemblies.

Optionally, the driven rotor is configured to rotate at the bottom of the cleaning chamber, or the driven rotor is configured to rotate on a cover surface of the cleaning cover that faces the bottom of the cleaning chamber.

Optionally, the cleaning assembly further includes a positioning shaft. The positioning shaft is fixed to the bottom of the cleaning chamber, and the driven rotor is rotatably mounted on the positioning shaft; or the positioning shaft is fixed to the cover surface of the cleaning cover that faces the bottom of the cleaning chamber, and the driven rotor is rotatably mounted on the positioning shaft.

Optionally, the cleaning cover is made of a metal material, and the bottom of the cleaning chamber is not magnetic.

Optionally, the driven rotor is provided with a plurality of turbulence-inducing grooves penetrating therethrough, wherein the turbulence-inducing grooves are uniformly distributed circumferentially around an axis of the driven rotor.

Optionally, the cleaning device further includes an ultrasonic cleaning module, the ultrasonic cleaning module being disposed in the cleaning box and configured to ultrasonically clean items placed within the cleaning chamber.

Optionally, the cleaning device further includes a heating module disposed in the cleaning box and configured to heat the water flow within the cleaning chamber.

Optionally, the cleaning box is further provided with a drying chamber, the drying chamber and the cleaning chamber being independent of each other.

In summary, the present disclosure includes at least one of the following beneficial technical effects: When the cleaning device is used to clean items such as makeup brushes, the items are placed in the cleaning chamber. The control mechanism then activates the cleaning device, causing the driving motor to operate. The output shaft of the driving motor rotates the driving rotor, which, through magnetic coupling, drives the driven rotor to rotate. This rotation generates turbulent water flow in the cleaning chamber, thereby cleaning the items. The non-contact power transmission via magnetic coupling eliminates the need for perforating the bottom of the cleaning chamber to directly connect the driving motor and driven rotor. As a result, the sealing integrity of the cleaning chamber is enhanced, preventing water seepage to the motor and addressing sealing issues prevalent in conventional cleaning devices due to bottom perforations.

### BRIEF DESCRIPTION OF THE DRAWINGS

FIG. 1 is a schematic view of the overall structure of the multi-functional cleaning system according to the present disclosure.

FIG. 2 is an exploded view of the overall structure of the multi-functional cleaning system according to the present disclosure.

FIG. 3 is an exploded view of the structure of the cleaning box of the multi-functional cleaning system according to the present disclosure.

FIG. 4 is a schematic view of the structure of the cleaning device of the multi-functional cleaning system according to the present disclosure.

FIG. 5 is a schematic view of the structure of the driving assembly of the multi-functional cleaning system according to the present disclosure.

FIG. 6 is a schematic view of the structure of the cleaning assembly of the multi-functional cleaning system according to the present disclosure.

FIG. 7 is a first schematic view of the structure of the control mechanism of the multi-functional cleaning system according to the present disclosure.

FIG. 8 is a second schematic view of the structure of the control mechanism of the multi-functional cleaning system according to the present disclosure.

FIG. 9 is a schematic view showing the installation of the heating module on the cleaning part of the multi-functional cleaning system according to the present disclosure.

FIG. 10 is a schematic view of the protective mesh disposed inside the cleaning chamber of the multi-functional cleaning system according to the present disclosure.

FIG. 11 is a schematic view of the structure of the positioning shaft of the multi-functional cleaning system according to the present disclosure.

### REFERENCE NUMERALS

1. cleaning box; 11. base part; 12. drying part; 121. drying chamber; 122. drying lid; 13. box body part; 131. placement groove; 132. cleaning lid; 14. cleaning part; 141. cleaning chamber; 2. cleaning device; 21. driving assembly; 211. driving motor; 212. driving rotor; 22. cleaning assembly; 221. driven rotor; 222. positioning shaft; 222a. first positioning shaft; 222b. second positioning shaft; 222c. third positioning shaft; 2211. turbulence-inducing groove; 222. positioning shaft; 23. cleaning cover; 24. ultrasonic cleaning module; 25. heating module; 26. drying module; 27. protective mesh; 3. control mechanism; 31. control circuit board; 32. display circuit board; 321. display module; 322. control button.

### DESCRIPTION OF EMBODIMENTS

The present disclosure will be further described in detail below with reference to the accompanying drawings 1-11.

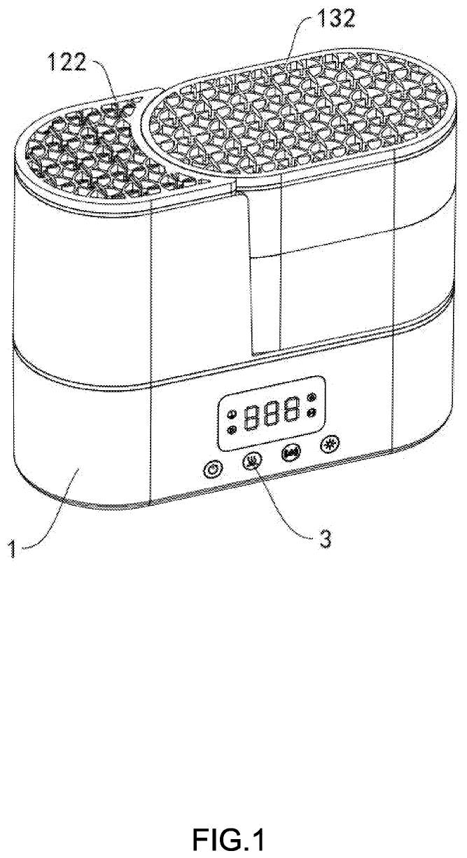

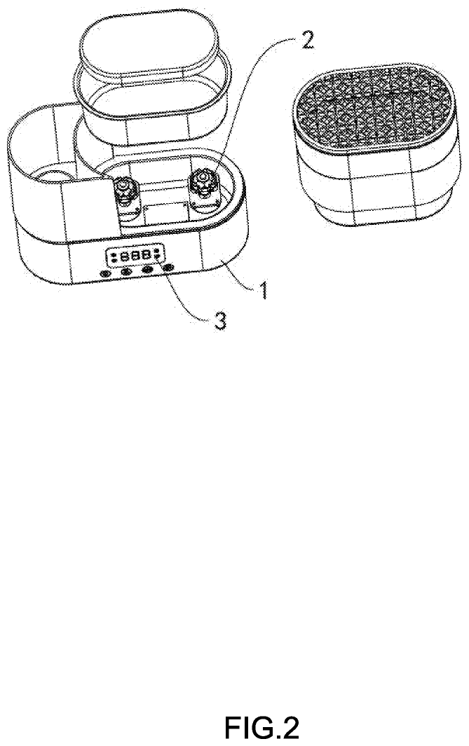

An embodiment of the present disclosure discloses a cleaning device for a multi-functional cleaning system, a multi-functional cleaning system, and a method of use thereof. Referring to FIG. 1 and FIG. 2, a multi-functional cleaning system includes a cleaning box 1, a cleaning device 2, and a control mechanism 3. Both the cleaning device 2 and the control mechanism 3 are disposed in the cleaning box 1. The cleaning device 2 is configured to clean items such as makeup brushes, and the control mechanism 3 is configured to control the cleaning device 2.

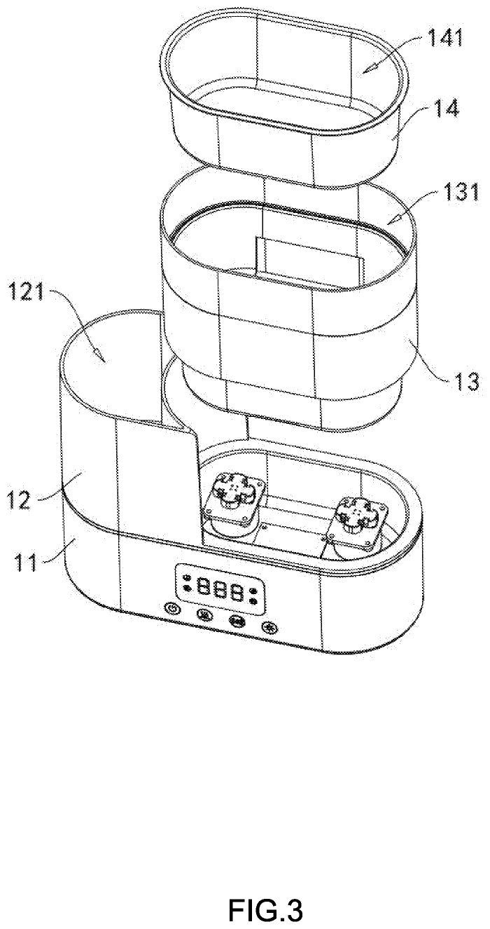

Referring to FIG. 1 and FIG. 3, the cleaning box 1 includes a base part 11, a drying part 12, a box body part 13, and a cleaning part 14. The drying part 12 is fixed to the top of the base part 11. The drying part 12 is provided with a drying chamber 121 for drying cleaned items. The body of the drying chamber 121 is provided with a drying lid 122. When the drying lid 122 is placed in the drying chamber 121, it covers the drying chamber 121. The box body part 13 is fixed to the top of the base part 11 and abuts the drying part 12. The box body part 13 is provided with a placement groove 131. The cleaning part 14 is placed in the placement groove 131 and cooperates with the box body part 13. The cleaning part 14 is provided with a cleaning chamber 141 for cleaning. The drying chamber 121 and the cleaning chamber 141 are independent of each other. The body of the placement groove 131 is provided with a cleaning lid 132. When the cleaning lid 132 is placed in the placement groove 131, it covers the placement groove 131. In this embodiment of the application, the bottom of the cleaning chamber 141 is not magnetic.

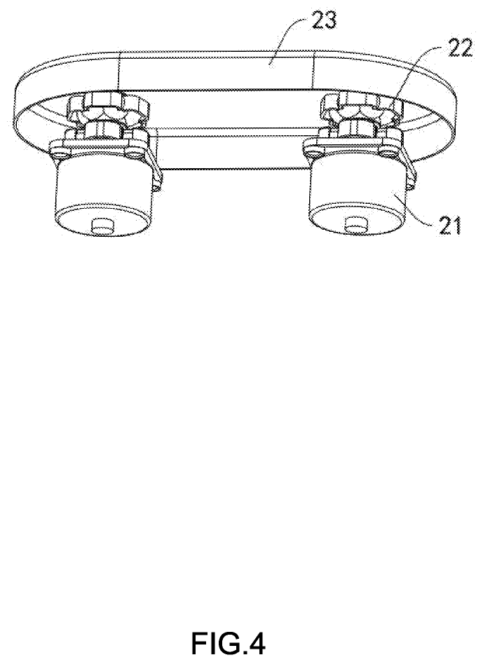

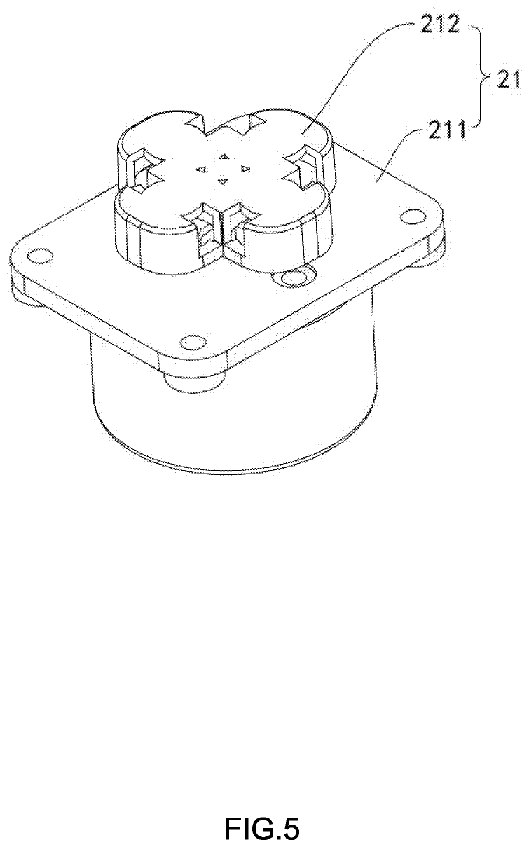

Referring to FIG. 4 and FIG. 5, the cleaning device 2 includes two driving assemblies 21 and two cleaning assemblies 22. Each driving assembly 21 is configured to drive a respective cleaning assembly 22. Both driving assemblies 21 are disposed in the base part 11. The driving assembly 21 includes a driving motor 211 disposed outside the cleaning chamber 141 and a driving rotor 212. The driving motor 211 is fixed in the base part 11. The driving rotor 212 is coaxially fixed to the output shaft of the driving motor 211. The driving rotor 212 is magnetic. Both cleaning assemblies 22 are disposed in the cleaning part 14 and inside the cleaning chamber 141. The cleaning assembly 22 is configured to clean items within the cleaning chamber 141.

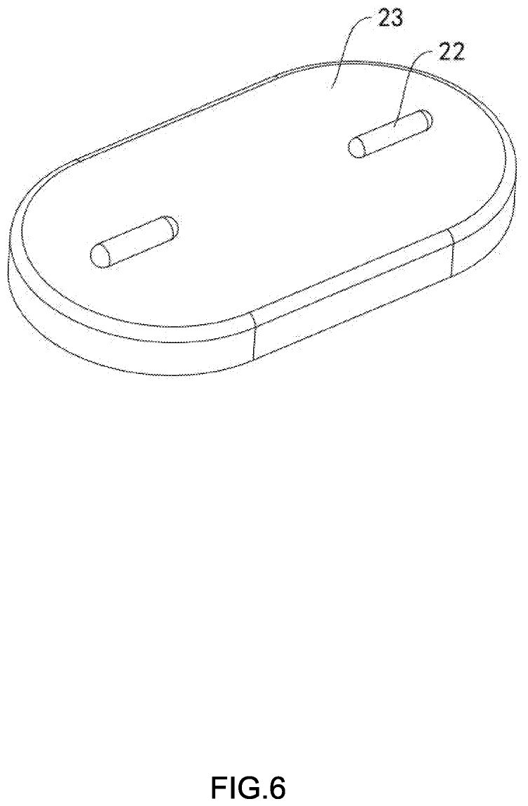

Referring to FIG. 4 and FIG. 6, the cleaning device 2 further includes a cleaning cover 23. In this embodiment of the application, the cleaning cover 23 is made of a metal material. The cleaning cover 23 is provided with mesh holes for water to pass through. The cleaning cover 23 is disposed inside the cleaning chamber 141 and is detachably connected to the cleaning box 1. The cleaning cover 23 is configured to cover each cleaning assembly 22 at the bottom of the cleaning chamber 141. Further, the cleaning cover 23 is maintained at the bottom of the cleaning chamber 141 by its own weight and covers the cleaning assemblies 22, so that when items are placed in the cleaning chamber 141 for cleaning, contact between the items and the cleaning assemblies 22 is avoided. This ensures that the cleaning assemblies 22 are less susceptible to interference from the items during operation. Additionally, each cleaning assembly 22 and the cleaning cover 23 form an integrated, replaceable unit.

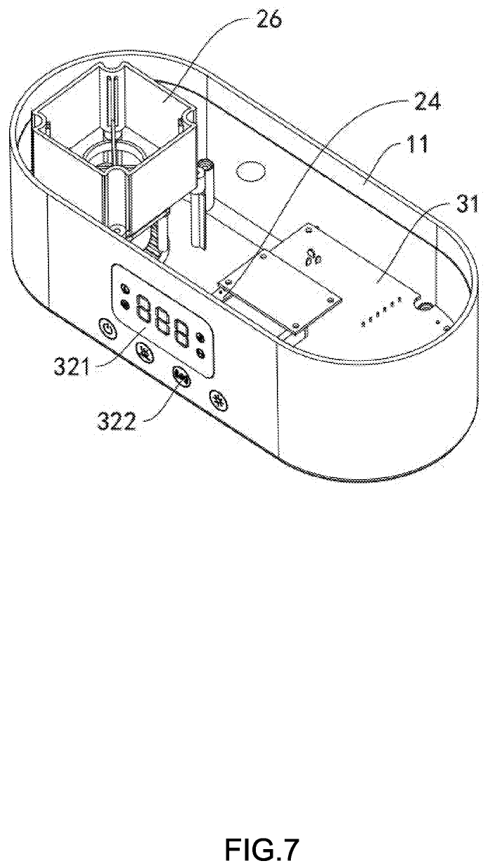

Referring to FIG. 4 and FIG. 7, the cleaning assembly 22 includes a driven rotor 221. The driven rotor 221 is magnetic. The driven rotor 221 is disposed inside the cleaning chamber 141 and is operatively positioned relative to the driving rotor 212. The driven rotor 221 is provided with a plurality of turbulence-inducing grooves 2211 penetrating therethrough. Each turbulence-inducing groove 2211 is uniformly distributed circumferentially around an axis of the driven rotor 221. The rotation of the driven rotor 221 generates turbulent water flow within the cleaning chamber 141. When the driving rotor 212 rotates under the power of the driving motor 211, it drives the driven rotor 221 to rotate via magnetic coupling. This achieves a non-contact drive of the driven rotor 221 by the driving motor 211, which avoids the need for direct connection between the driving motor 211 and the driven rotor 221 that would require perforating the bottom of the cleaning chamber. Consequently, the sealing integrity of the cleaning chamber is enhanced, ensuring the sealing of the cleaning chamber of the device, preventing water from seeping to the motor, and resolving the sealing issue in existing cleaning devices caused by perforations at the bottom of the cleaning chamber.

In some embodiments, the driven rotor 221 can be rotatably disposed at the bottom of the cleaning chamber 141, or the driven rotor 221 can be rotatably disposed on the cover surface of the cleaning cover 23 that faces the bottom of the cleaning chamber 141.

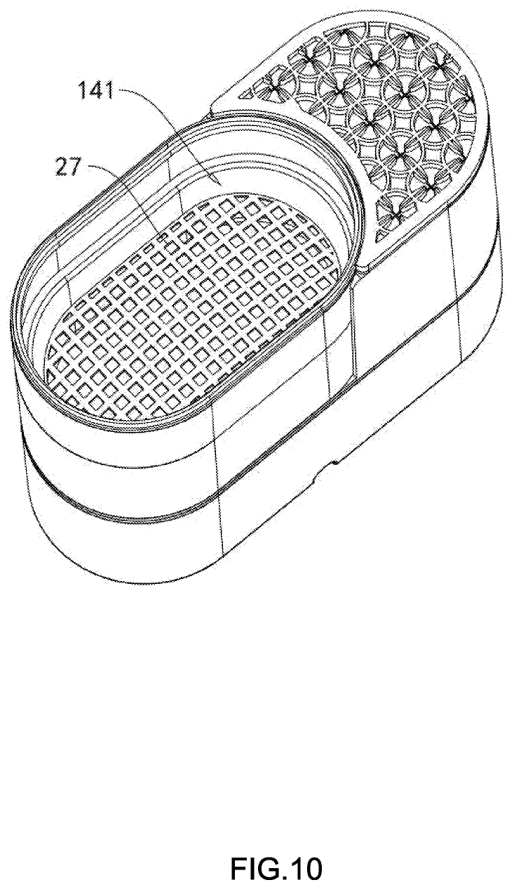

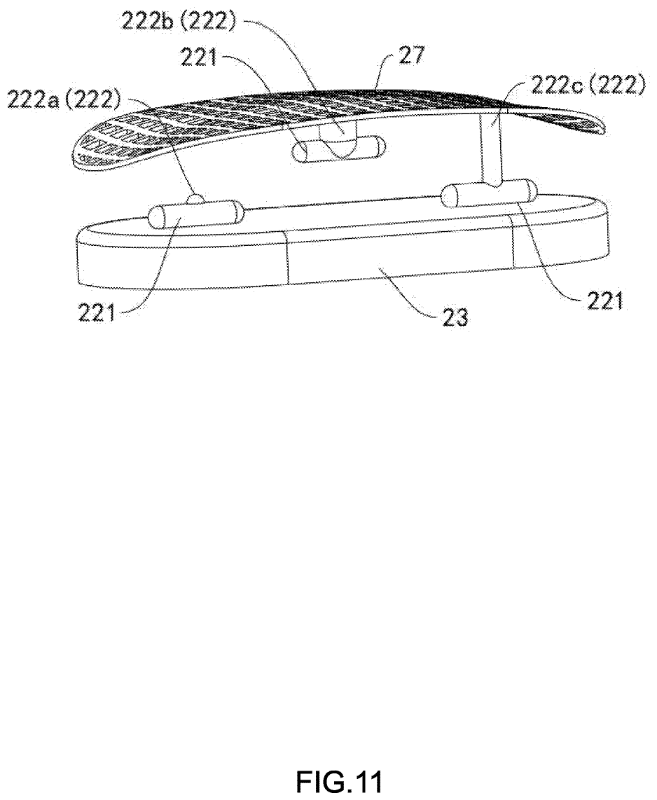

Referring to FIG. 4 through FIG. 11, the cleaning assembly 22 can also include a positioning shaft 222. The positioning shaft 222 is rotationally connected to the driven rotor 221.

The positioning shaft 222 can be a first positioning shaft 222a, wherein the first positioning shaft 222a is fixedly connected to the cleaning cover 23.

The positioning shaft 222 can be a second positioning shaft 222b, wherein the second positioning shaft 222b is fixedly connected to the protective mesh 27 and positions the driven rotor 221 close to the protective mesh 27.

The positioning shaft 222 can be a third positioning shaft 222c, wherein the third positioning shaft 222c is fixedly connected to the protective mesh 27 and positions the driven rotor 221 close to the cleaning cover 23.

This configuration improves the stability of power transmission between the driven rotor 221 and the driving rotor 212. The driven rotor 221 can rotate independently within the cleaning chamber 141 to clean the items. The driven rotor 221 can also be connected to the cleaning cover 23 via the positioning shaft 222, which makes the rotational position of the driven rotor 221 more stable, thereby enhancing the cleaning effect on the items. Alternatively, in other arrangements, the positioning shaft can be fixed to the bottom of the cleaning chamber 141, and the driven rotor is rotatably mounted on the positioning shaft, thereby causing the driven rotor to be rotatably disposed at the bottom of the cleaning chamber.

In some embodiments, the driven rotor 221 may be rotatably disposed at the bottom of the cleaning chamber 141, or the driven rotor 221 may be rotatably disposed on the cover surface of the cleaning cover 23 that faces the bottom of the cleaning chamber 141.

Referring to FIG. 4 and FIG. 6, the cleaning assembly 22 further includes a positioning shaft 222. The positioning shaft 222 is rotationally connected to the driven rotor 221. The positioning shaft 222 is fixedly connected to the cleaning cover 23, which improves the stability of power transmission between the driven rotor 221 and the driving rotor 212. The driven rotor 221 may rotate independently within the cleaning chamber 141 to clean the items. The driven rotor 221 may alternatively be connected to the cleaning cover 23 via the positioning shaft 222, which makes the rotational position of the driven rotor 221 more stable, thereby enhancing the cleaning effect on the items. Alternatively, in other arrangements, the positioning shaft may be fixed to the bottom of the cleaning chamber 141, and the driven rotor may be rotatably mounted on the positioning shaft, thereby enabling the driven rotor to be rotatably disposed at the bottom of the cleaning chamber.

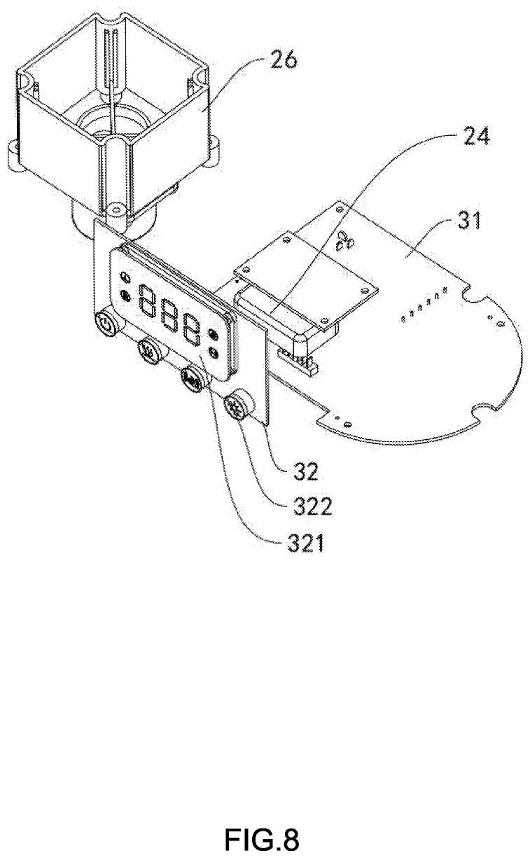

Referring to FIG. 8 through FIG. 11, the cleaning device 2 further includes an ultrasonic cleaning module 24, a heating module 25, a drying module 26, a temperature monitoring module, and a protective mesh 27. The ultrasonic cleaning module 24 is disposed in the base part 11 and is configured to perform ultrasonic cleaning on items placed within the cleaning chamber 141. The heating module 25 is disposed in the cleaning part 14 and is configured to heat the water flow within the cleaning chamber 141. The drying module 26 is disposed in the base part 11 and is configured to dry the items placed in the drying chamber 121. The temperature monitoring module is disposed in the base part 11 and is used for real-time monitoring and control of the temperature of the cleaning device to prevent overheating. The protective mesh 27 is disposed in the cleaning chamber 141 and covers the top of each cleaning assembly 22 to protect each cleaning assembly 22.

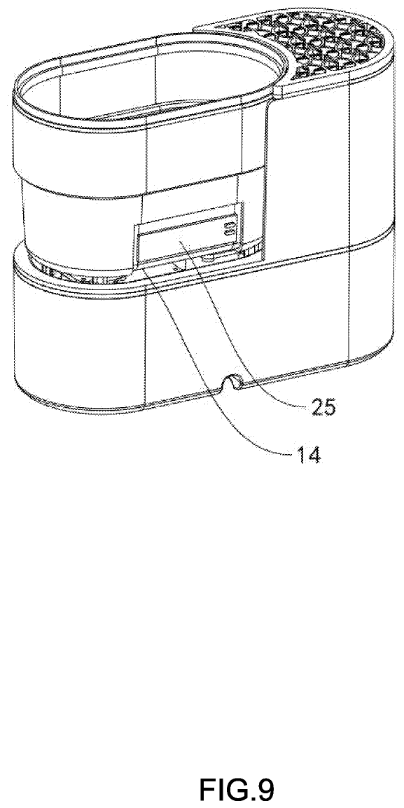

Referring to FIG. 8 and FIG. 9, the control mechanism 3 includes a control circuit board 31 and a display circuit board 32. The control circuit board 31 is disposed in the base part 11. The control circuit board 31 is electrically connected to each driving motor 211 to control each driving motor 211. The control circuit board 31 is electrically connected to the ultrasonic cleaning module 24 to control the ultrasonic cleaning module 24. The control circuit board 31 is electrically connected to the heating module 25 to control the heating module 25. The control circuit board 31 is electrically connected to the drying module 26 to control the drying module 26. The control circuit board 31 is electrically connected to the temperature monitoring module to facilitate control over the temperature monitoring module. The display circuit board 32 is fixed to the base part 11. The display circuit board 32 is electrically connected to the control circuit board 31. The display circuit board 32 is provided with a display module 321 and multiple control buttons 322 to allow a user to control the cleaning device.

Thus, in the multi-functional cleaning system of the present disclosure, the rotation of the driven rotor 221 generates turbulent water flow for agitating and cleaning items. The ultrasonic cleaning module 24 is configured to perform ultrasonic cleaning. The heating module 25 is configured to heat the water flow, allowing for cleaning with warm water to improve the cleaning effect. Additionally, the drying part 12 is configured to dry the cleaned items, realizing a multi-functional cleaning capability.

The operating principle of an embodiment of the multi-functional cleaning system of the present disclosure is as follows: when the cleaning device is used to clean items such as makeup brushes, the items are placed in the cleaning chamber 141. Subsequently, the control mechanism 3 activates the cleaning device 2, which causes the driving motor 211 to operate. The output shaft of the driving motor 211 drives the driving rotor 212 to rotate. The magnetic coupling between the driving rotor 212 and the driven rotor 221 drives the driven rotor 221 to rotate. The rotation of the driven rotor 221 causes the water in the cleaning chamber 141 to generate turbulent flow. This achieves the cleaning of items like makeup brushes inside the cleaning chamber 141. The transmission between the driving rotor 212 and the driven rotor 221 is via magnetic coupling, which is a non-contact transmission method. This avoids the need for direct connection between the driving motor 211 and the driven rotor 221, which would require perforating the bottom of the cleaning chamber 141. This improves the sealing of the cleaning chamber 141, ensuring the watertightness of the cleaning chamber 141 of the cleaning device and preventing water from seeping to the motor.

A method for using the multi-functional cleaning system includes the following steps: placing items to be cleaned into the cleaning chamber 141 of the multi-functional cleaning system; and starting the driving motor 211 of the multi-functional cleaning system, thereby driving the driven rotor 221 to rotate via the driving rotor 212 through magnetic coupling, causing the driven rotor 221 to generate turbulence for cleaning the items with the turbulent flow.

The method also includes activating the ultrasonic module to perform ultrasonic vibration cleaning on the items. This is achieved by operating the control button 322 of the control mechanism 3 to activate the ultrasonic module.

The method also includes activating the heating module 25 to raise the temperature of the water flow in the cleaning chamber 141.

The method also includes adjusting the rotation of the driving motor 211 via the control mechanism 3.

The method also includes, after the items are cleaned, detaching the cleaning cover 23 of the cleaning device 2 to remove the cleaning cover 23 from the cleaning chamber 141.

The method also includes connecting the positioning shaft 222 of the cleaning assembly 22 with the driven rotor 221 to apply axial pressure to the driven rotor 221, thereby causing the driven rotor 221 to rotate circumferentially about the axis.

The bottom of the cleaning chamber 141 is not magnetic.

The driven rotor 221 is provided with a plurality of turbulence-inducing grooves 2211 penetrating therethrough. The turbulence-inducing grooves 2211 are uniformly distributed circumferentially around an axis of the driven rotor 221, enabling the driven rotor 221 to generate turbulence.

The method also includes controlling, via the control mechanism 3, the activation or deactivation of at least one of the driving motor 211, the ultrasonic module, and the heating module 25 to clean the items.

The foregoing are only preferred embodiments of the present disclosure and are not intended to limit the scope of the present disclosure. Therefore, any equivalent changes made based on the structure, shape, or principle of the present disclosure should fall within the scope of protection of the present disclosure.

What is claimed is:

1. A cleaning device for a multi-functional cleaning system, comprising:
at least one driving assembly and at least one cleaning assembly, each driving assembly being configured to drive a respective cleaning assembly;
wherein the driving assembly comprises a driving motor disposed outside a cleaning chamber of the cleaning system and a driving rotor coaxially fixed to an output shaft of the driving motor;
wherein the cleaning assembly comprises a driven rotor disposed inside the cleaning chamber and operatively positioned relative to the driving rotor;
wherein both the driving rotor and the driven rotor are magnetic; and
wherein rotation of the driving rotor drives the driven rotor to rotate via magnetic coupling to generate turbulent water flow within the cleaning chamber.

2. The cleaning device according to claim 1, further comprising a cleaning cover, the cleaning cover having mesh holes for water to pass through, the cleaning cover being disposed within the cleaning chamber, and the cleaning cover covering each cleaning assembly at a bottom of the cleaning chamber.

3. The cleaning device according to claim 2, wherein the cleaning cover is detachably connected to a cleaning box.

4. The cleaning device according to claim 2, wherein the cleaning cover is maintained at the bottom of the cleaning chamber by its own weight and covers the at least one cleaning assembly.

5. The cleaning device according to claim 4, wherein the driven rotor is configured to rotate at the bottom of the cleaning chamber, or the driven rotor is configured to rotate on a cover surface of the cleaning cover that faces the bottom of the cleaning chamber.

6. The cleaning device according to claim 5, wherein the cleaning assembly further comprises a positioning shaft;
the positioning shaft is fixed to the bottom of the cleaning chamber, and the driven rotor is rotatably mounted on the positioning shaft; or the positioning shaft is fixed to the cover surface of the cleaning cover that faces the bottom of the cleaning chamber, and the driven rotor is rotatably mounted on the positioning shaft.

7. The cleaning device according to claim 1, wherein the driven rotor is provided with a plurality of turbulence-inducing grooves penetrating therethrough, and the plurality of turbulence-inducing grooves are uniformly distributed circumferentially around an axis of the driven rotor.

8. The cleaning device according to claim 1, further comprising an ultrasonic cleaning module configured to ultrasonically clean items placed within the cleaning chamber.

9. The cleaning device according to claim 1, further comprising a heating module configured to heat water flow within the cleaning chamber.

10. A multi-functional cleaning system, comprising:
a cleaning box, a cleaning device, and a control mechanism, wherein the cleaning box is provided with a cleaning chamber for cleaning;
wherein the cleaning device comprises at least one driving assembly and at least one cleaning assembly, each driving assembly being configured to drive a respective cleaning assembly;
wherein the driving assembly comprises a driving motor disposed in the cleaning box and outside the cleaning chamber, and a driving rotor coaxially fixed to an output shaft of the driving motor;
wherein the cleaning assembly comprises a driven rotor disposed inside the cleaning chamber and operatively positioned relative to the driving rotor;
wherein both the driving rotor and the driven rotor are magnetic; and
wherein rotation of the driving rotor drives the driven rotor to rotate via magnetic coupling to generate turbulent water flow within the cleaning chamber; and
wherein the control mechanism is disposed in the cleaning box and is configured to control the cleaning device.

11. The multi-functional cleaning system according to claim 10, wherein the cleaning device further comprises a cleaning cover, the cleaning cover having mesh holes for water to pass through, the cleaning cover being disposed within the cleaning chamber, and the cleaning cover covering each cleaning assembly at a bottom of the cleaning chamber.

12. The multi-functional cleaning system according to claim 11, wherein the cleaning cover is detachably connected to the cleaning box.

13. The multi-functional cleaning system according to claim 11, wherein the cleaning cover is maintained at the bottom of the cleaning chamber by its own weight and covers the at least one cleaning assembly.

14. The multi-functional cleaning system according to claim 13, wherein the driven rotor is configured to rotate at the bottom of the cleaning chamber, or the driven rotor is configured to rotate on a cover surface of the cleaning cover that faces the bottom of the cleaning chamber.

15. The multi-functional cleaning system according to claim 14, wherein the cleaning assembly further comprises a positioning shaft;
the positioning shaft is fixed to the bottom of the cleaning chamber, and the driven rotor is rotatably mounted on the positioning shaft; or the positioning shaft is fixed to the cover surface of the cleaning cover that faces the bottom of the cleaning chamber, and the driven rotor is rotatably mounted on the positioning shaft.

16. The multi-functional cleaning system according to claim 11, wherein the cleaning cover is made of a metal material, and the bottom of the cleaning chamber is not magnetic.

17. The multi-functional cleaning system according to claim 10, wherein the driven rotor is provided with a plurality of turbulence-inducing grooves penetrating therethrough, and the plurality of turbulence-inducing grooves are uniformly distributed circumferentially around an axis of the driven rotor.

18. The multi-functional cleaning system according to claim 10, wherein the cleaning device further comprises an ultrasonic cleaning module disposed in the cleaning box and configured to ultrasonically clean items placed within the cleaning chamber.

19. The multi-functional cleaning system according to claim 10, wherein the cleaning device further comprises a heating module disposed in the cleaning box and configured to heat water flow within the cleaning chamber.

20. The multi-functional cleaning system according to claim 10, wherein the cleaning box is further provided with a drying chamber, the drying chamber and the cleaning chamber being independent of each other.
